(19) United States
(12) Patent Application Publication
(10) Pub. No.: US 2018/0279668 A1
(43) Pub. Date: Oct. 4, 2018

(54) UNIVERSAL AUTOMATIC CIGARETTE MAKING MACHINE

(71) Applicants: CHI TAU CHAN, Toronto (CA); Catherine Ket Wah Kan, Toronto (CA)

(72) Inventors: CHI TAU CHAN, Toronto (CA); Catherine Ket Wah Kan, Toronto (CA)

(21) Appl. No.: 15/478,217

(22) Filed: Apr. 3, 2017

(51) Int. Cl. A24C 5/02; A24C 5/34; A24C 5/32

(52) U.S. Cl. CPC A24C 5/02; G06F 3/04847; A24C 5/321; A24C 5/34

(57) ABSTRACT

An automatic cigarette-making machine includes a material bin for receiving and selectively dispensing a loose combustible substance suitable to be received and packed within a hollow tube to form a cigarette. A tube bin receives and selectively dispenses hollow tubes. A tube transporting carriage selectively receives a tube from the tube bin and selectively transports a tube between positions at the tube bin and filling station. Filling apparatus selectively moves the combustible substance from the material bin into a tube at the filling station. A pressure sensor is movably positionable proximate to a tube being filled at the filling station to measure or monitor pressure of the combustible substance within the tube while it is being filled. A user interface allows a user to select a desired packing density or pressure within the tube while it is being filled and/or the number of cigarettes to be automatically produced.

### BACKGROUND OF THE INVENTION

### 1. Field of the Invention

The invention generally relates to material packing machines and, more specifically, to a universal automatic cigarette making machine.

### 2. Description of the Prior Art

Small size cylinder form packing machines have been proposed. More specifically, cigarette packing machines have been proposed for producing cigarettes from botanical substances not limited to tobacco, herbs, plants, spices, herbaceous plants including leaves, roots, flowers, seeds, resins, root bark, inner bark (and canbium), berries and the pericarp or other portions of the plant; foods, as well as pharmaceuticals. Some example of botanicals that could be used as additives, or in a mixture may include but not limited to camomille, damiana, eucalyptus, green tea, lavender, lemon balm, marijuana, passion flower, peppermint, raspberry plant, sage, spearmint and thyme.

In a traditional packing process, an object to be packed, such as tobacco, is placed into a box, a bag, a canister or a sleeve, or certain foldable soft materials. The foregoing packing material could be used to pack a solid product placed into a foldable soft packing material, into a box, into a bag or into a canister. In addition, it is noted that packing approaches are carried out according to certain factors such as space, volume, thickness, density, weight and the like; without considering the uniformity and tightness of the product to be packed. However, users frequently have specific requirements about the density of packing. In certain cases, there are specific requirements for the uniformity and tightness of the packed product in a hollow tube or sleeve.

For example, as for the packing of tobacco, food and drugs, they have specific requirement for both uniformity and tightness of the packed products depending on customer preferences.

Known cigarette making machines, especially those designed for consumer private or home use, have been very limited both in terms of flexibility of use as well as the nature or quality of the resulting cigarette products. Most have focused on making individual cigarettes having the same or uniform properties. For example, semi-automatic cigarette-making machines disclosed in U.S. Pat. Nos. 9,277,766; 9,179,705 and 7,066,183 compact loose tobacco into rod-like tobacco shapes and then insert them into hollow cigarette tubes or sleeves. However, by first compacting the tobacco into a rod-like tobacco shape, prior to filling the tube with tobacco, limits the degree to which the tobacco can be compacted prior to insertion into the tube. Clearly, if the tobacco is too loose it may not attain or retain its desired rod-like dimensions necessary for insertion into the tube. This necessarily requires these known machines to compact the tobacco to relatively high densities, limiting the user from making cigarettes with lower tobacco densities.

### SUMMARY OF THE INVENTION

The objective of the present invention is to provide a universal automatic packing machine that can meet all consumer requirements. The present invention is able to solve the technical problem while enabling the processing of packing tobacco, herbs, plants, botanical herbs, herbaceous plants, food or drug products, or any combination thereof, ensuring uniformity independently of the nature of the cigarettes that are made, enabling easy user adjustments to maintain a suitable or desired tightness of the packed product independently of the materials or substances used to make the cigarettes, and doing so entirely in a compact and portable automated machine suitable for home or private use. Where control compliance is required such as in the case of tobacco, marijuana and any controlled substances, the machine may include a QR-Code reader, be Bluetooth enabled or otherwise have the ability to recognize a code identifying a product or material on a product or package for data input that allows automatic setting of the machine or adjustments of the machine to set suitable or appropriate cigarette parameters.

### BRIEF DESCRIPTION OF THE DRAWINGS

Other objects and advantages of the present invention will be readily apparent to those skilled in the art from the following description of the drawings in which an exemplary embodiment of the invention is shown.

FIG. 1 is a perspective view of a universal automatic cigarette making machine in accordance with the present invention;

FIG. 2 is a frontal perspective graphical representation of the machine shown in FIG. 1 with the cover or housing removed;

FIG. 3 is a rear perspective graphical representation of the machine shown in FIG. 2;

FIG. 4 is a cross-sectional view of the machine, taken along line 4-4 in FIG. 1, through the material bin;

FIG. 5 is a front elevational view of a material separator within the material bin; FIG. 6 is a side elevational view of the material separator shown in FIG. 5;

FIG. 7 is a top plan view of the machine shown in FIGS. 1-3 with the cover or housing and tube bin removed;

FIG. 8 is an enlarged cross-sectional view of the machine shown in FIGS. 1-3, taken along line 8-8 in FIG. 7, showing details of a gear train used in the machine shown in FIGS. 1-3;

FIG. 9 is a schematic diagram of the controller and the electronic and electro-mechanical components connected thereto;

FIG. 10 is part 1 of a 2-part flowchart showing the manner in which the controller shown in FIG. 9 is programmed to perform preliminary operations for making one or more cigarettes; and

FIG. 11 is part 2 of the 2-part flowchart showing the manner in which the controller shown in FIG. 9 is programmed to perform the operations for making one or more cigarettes.

### DESCRIPTION OF A PRESENTLY PREFERRED EMBODIMENT

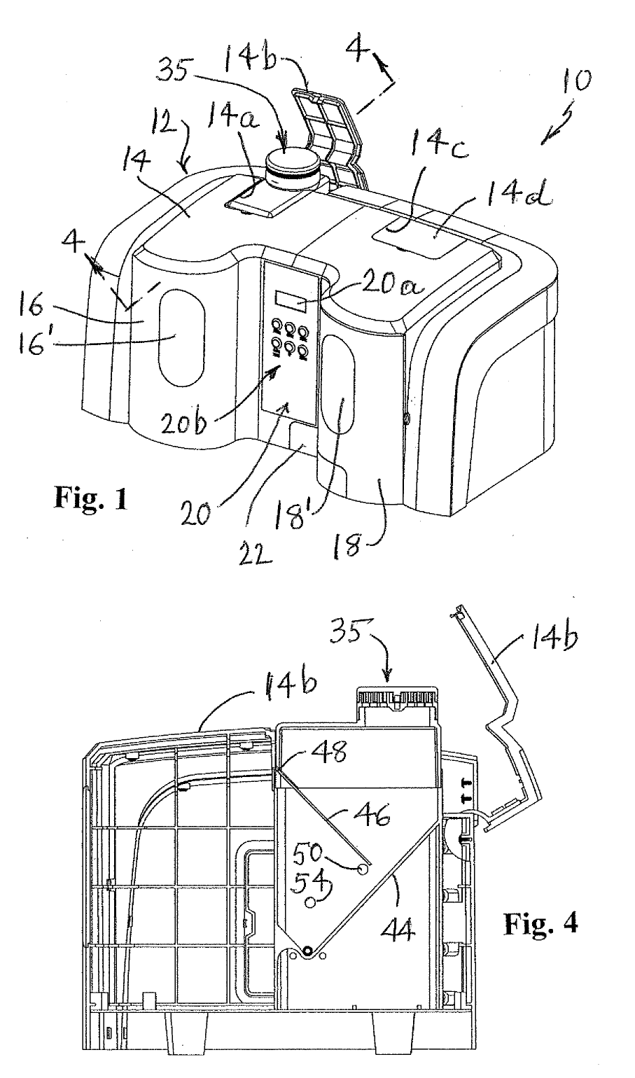

Referring now specifically to the Figures, and first referring to FIG. 1, a universal automatic cigarette making machine in accordance with the present invention is generally designated by the reference numeral 10.

The cigarette machine 10 includes a housing 12 having a top wall 14. The top wall 14 includes a top material entry opening or port 14a on the left side of the housing 12, as viewed in FIG. 1, and a cover 14b mounted for pivoting between an open condition as shown in FIG. 1 and a closed position for closing the opening or port 14a. An entry port or opening 14c is provided on the right side of the housing 12, as shown, that can be selectively opened or closed by a cover 14d. The openings or ports 14a and 14c are in alignment with associated bins, as to be more fully described below.

The housing 12 preferably also includes a left front panel 16 provided with a window 16′, and a right front panel 18 provided with a window 18′, the panels 16, 18 preferably also being mounted to either be removable or pivotable in a manner to expose and provide access to those parts or components of the internal machine behind the panels.

The housing 12 also includes a control panel 20, between the left and right panels 16, 18 that serves as the electronic user interface for entering data or desired cigarette parameters and includes a display 20a and a plurality of control buttons 20b, to be more fully described below. A slidably mounted drawer 22 is provided for removing finished cigarettes.

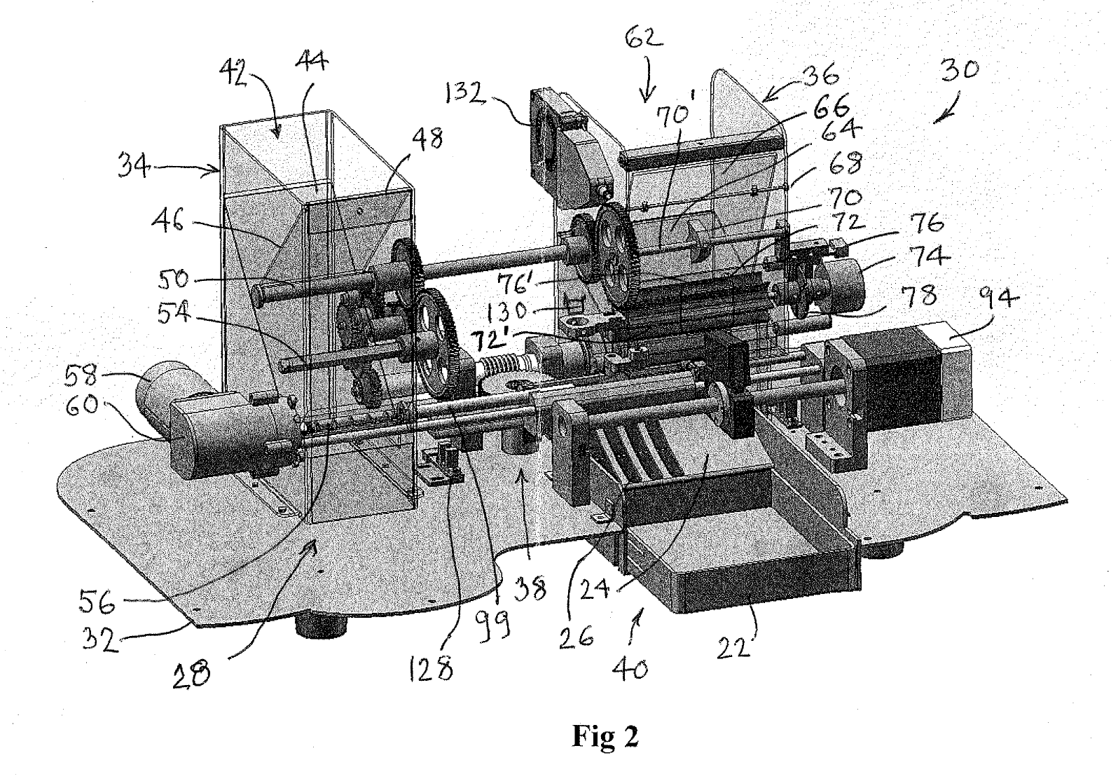

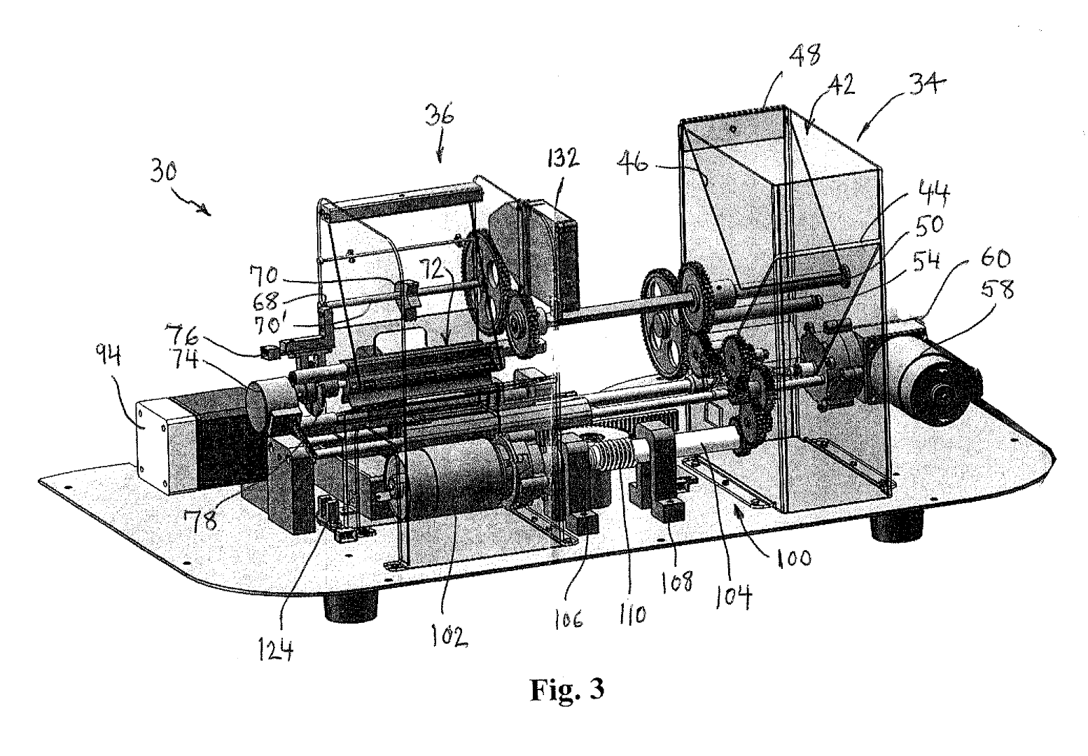

Referring to FIGS. 2 and 3, the internal components or parts of the machine core 30 are illustrated for producing cigarettes in accordance with parameters or desired attributes selected by a user. In FIG. 2 a downwardly sloping chute 24 is shown upwardly and rearwardly of the drawer 22. A plurality of holes or slots 26 are provided in the chute 24 to receive loose tobacco droppings from the finished cigarettes that are emptied into the drawer 22.

The internal components of the machine 10 are generally designated as the machine core 30. The machine core 30 includes a base or support platform 32 on which there is mounted a material bin 34, on the left side of the base or platform 32, as viewed in FIG. 2, and a tube bin 36 on the opposite lateral or right side of the base or platform. The material bin 34 is positioned to receive material through the material entry opening or port 14a in the top wall 14 while the empty tube bin 36 is positioned to receive empty or hollow cigarette tubes or sleeves dropped or inserted through the tube entry opening or port 14c.

The right side of the machine core 30, as viewed from the front in FIGS. 1 and 2, where the empty tube bin 36 is positioned, will be referred to as the tube filling station 38. The intermediate position of the machine core, in the region of the drawer 22, will be referred to as the finished cigarette receiving station 40. The left side of the machine core 30, where the material bin 34 is positioned, will be referred to as the material discharging or dispensing station 28.

The material bin 34 has an upper opening 42, aligned with material entry opening or port 14a for receiving material passed there-through. The material bin includes a fixed inclined panel 44 that extends along a substantial portion of the height of the material bin 34, as shown. A second inclined panel 46 is pivotally mounted along an upper edge 48 of the material bin, such as by means of a piano hinge. The lower portion of the inclined panel 46 terminates along an intermediate height position of the fixed panel 44 and is movable along the fixed panel 44 to serve as a gate for increasing or reducing the amount of material that can reach the lower portion or discharge region of the fixed panel 44. The movements of the pivoted or movable panel 46 is regulated by a shaft 50 that includes at least one protuberance on the surface thereof for interacting with the panel 46 and forcing it to move up or down relative to the fixed panel 44.

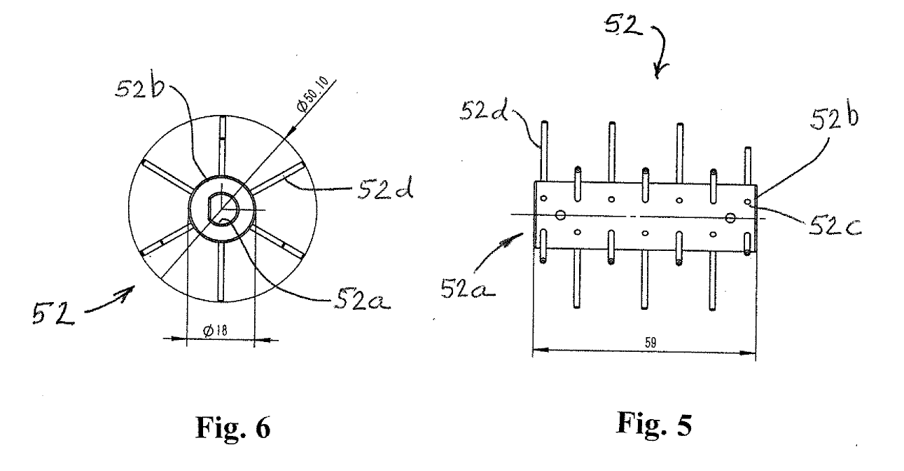

A material separator 52, shown in FIGS. 5 and 6, is mounted on a second shaft 54 that extends into the material bin at a point below the movable or pivoted panel 46. The shaft 54 includes a longitudinal flat surface 54′ (FIG. 4) and is dimensioned to be received within a channel 52a of a cylinder 52b of the separator 52. The cylinder 52b is provided with an array of holes 52c that receive a plurality of radial pins 52d that extend about the periphery of the cylinder 52b. The separator 52 is designed to agitate and at least partially separate material that has dropped below the panel 46 to render the material substantially uniformly loose so that the material has a substantially uniform density when it leaves the material bin 34.

Referring to FIG. 2, the separated material is dropped, under the action of gravity, onto a feeding auger 56 mounted for rotation and coupled to a DC motor 58. The motor 58 operates through gears, such as bevel gears, within housing or cover 60 to enable a reduction in the width of the machine core 30. Rotation of the motor 58 rotates the feeding auger 56 to advance tobacco and/or other material from the material discharging or dispensing station 28 towards the right, as viewed in FIGS. 1 and 2.

The tube bin 36 has an upper tube bin opening 62 and an inclined tube support panel 64 that slopes forwardly as shown in FIG. 2. The opening 62 is vertically aligned below the entry opening or port 14c in the housing 12 to allow empty cigarette tubes or tubes to be dropped through the opening 14c onto the tube support panel 64 to advance the tubes, due to gravity, towards the front of the empty tube bin 36. A second panel serves as a gate 66 that is mounted for pivotal rotation about pivot shaft 68 between a lowered closed condition inhibiting empty tubes from leaving the bin and a raised position that allows a tube to exit from the bin 36. A cam 70 is mounted on a gear actuated shaft 70′. Rotation of the shaft 70′ rotates the cam 70 to lift the gate 66 to selectively release an empty tube. The shaft 70′ is coupled, by means of gears of a gear train, to be described, that rotates shafts 50, 54, 70′ as well as other components, as to be described. When the gate 66 is raised to allow an empty tube to be released from the tube bin 36 it is dropped onto a rotatably mounted tube receiver 72 formed with a plurality of angularly offset longitudinal channels 72′ each dimensioned to receive an empty tube as it is released by the gate 66. A step motor 74 controls the rotation of the tube receiver 72, synchronized with other activations of components as to be described. A slotted disc 78 is mounted for rotation with the rotation of the tube receiver 72 to monitor the movements and positions of the tube receiver. The slotted disc cooperates with an optical sensor 76 that can detect when a slotted portion of the disc 78 passes there-through.

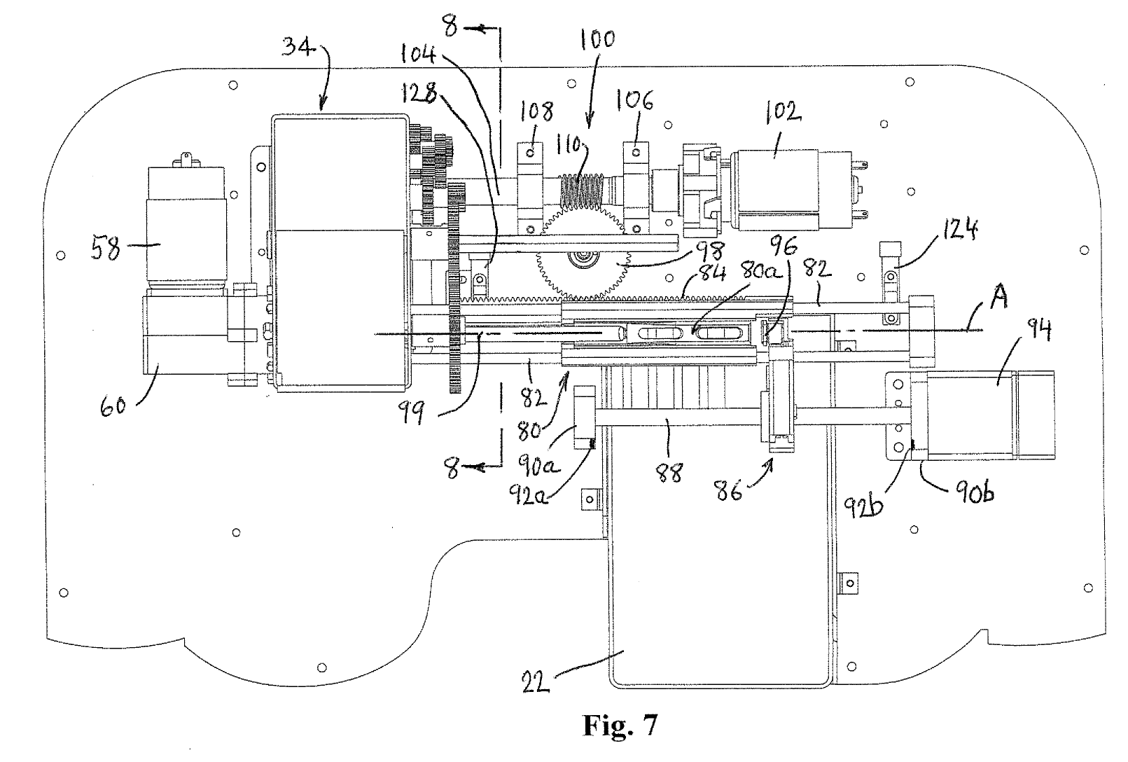

A tube carriage 80 is mounted for slidable movements between the location of the tube receiver 72 and the tube filling station 38. The tube carriage 80 is provided with an upwardly facing trough 80a to allow a tube to be dropped into and received on the tube carriage. The tube carriage 80 is slidably mounted on tracks 82 (FIG. 7). The tube carriage 80 is provided with a rack 84 on one side thereof (FIGS. 3 and 7). Proximate to the tube carriage 80 there is provided a pressure sensor carriage 86 mounted on a threaded shaft 88 supported on brackets 90a, 90b (FIG. 7), switches 92a and 92b being provided on the brackets 90a, 90b for detecting when the pressure sensor carriage 86 has reached a leftmost position or a rightmost position, respectively. A step motor 94 is provided that can selectively rotate the threaded shaft 88 in one direction or in an opposite direction to move the pressure sensor carriage 86 in the direction of the tube carriage 80 or away from that carriage. This makes it possible to move the carriage 86, and a pressure sensor 96 supported thereon, towards or away from the tube carriage 80, as shown in FIG. 7, to facilitate an empty tube to drop within the trough 80a without interference of the pressure sensor 96. The rack 84 is coupled to a pinion gear 98 for selectively moving the tube carriage 80 towards the right to be coextensive or in close proximity to the tube receiver 72 or towards the left in the direction of the feeding tube 99 that houses the feeding auger 56.

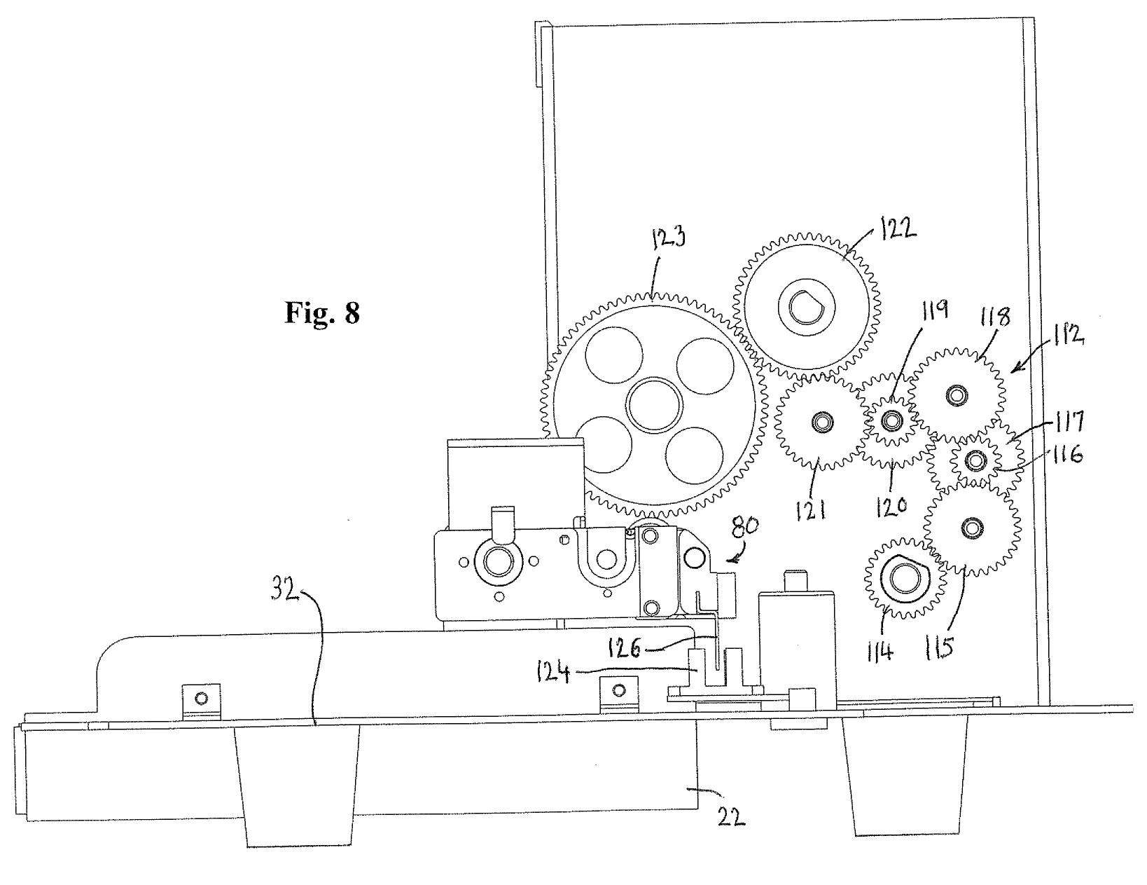

As suggested, the shafts 50, 54 and 70′ are driven by a drive train 100 (FIG. 7) consisting of coupled gears. The drive train 100 is actuated by a motor 102 that drives a shaft 104 rotatably mounted on brackets 106, 108. A worm gear 110 is provided on the shaft 104 for driving the pinion gear 98 which, in turn, transmits motion to the rack 84. As is clear from FIGS. 1, 2, 7 and 8, the shaft 104 is mechanically coupled to a system of gears 112 including gears 114-123 (FIG. 8) to provide rotary motion as well as synchronized gear changing speeds or reductions in order to rotate shafts 50, 54 and 70′ and their associated gears at desired rotational speeds. Actuation of the motor 102, therefore, allows material within the bin 34 to be agitated, separated and released. Empty tubes released at a rightmost position of the tube carriage 80 is detected when a plate 126 (FIG. 8) fixed to the tube carriage 80 for movements therewith is received within the photo-optical sensor 124.

A photo-optical sensor 124 (FIGS. 3 and 8) is provided at the rightmost position of the travel of the tube carriage 80 that carries with it the downwardly projecting plate 126 that is received within the photo-optical sensor 124 to establish when the tube carriage 80 has reached its rightmost position. Similarly, the leftmost position of the carriage 80 is established when the plate 126 is received within a photo-electric sensor 128. The photo-electric sensors 124 and 128 generate the electrical information that is used in the operation of the machine, as will be clear from the description that follows.

An empty tube detection sensor 130 is mounted above the tube carriage 80 to detect when an empty tube has been dropped into and is present on the tube carriage. A fan 132 is used to direct a stream of air through a blower or fan tube 134 to remove excess tobacco or other material from the auger 56 feeding tube 99 to ensure that there are no obstacles that could prevent free advancement of an empty tube into the feeding tube 99 at the tube feeding station 38.

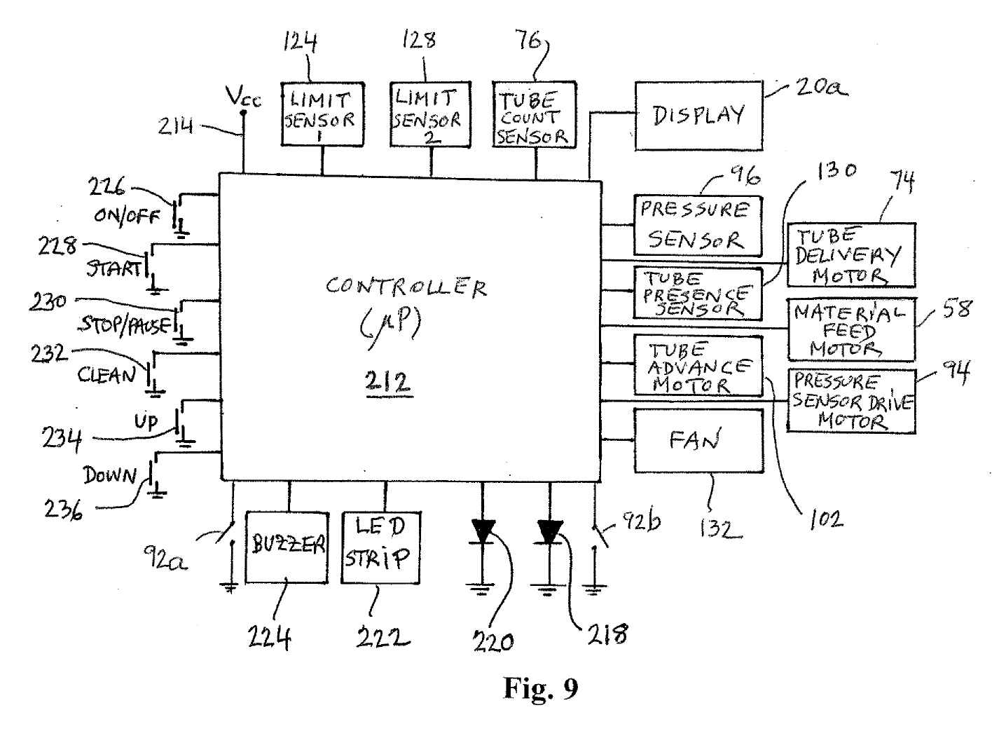

The operation and synchronization of the various component parts of the machine core 30 is regulated by controller 212, shown in FIG. 9, which can be a dedicated microprocessor chip or a microcontroller programmed to perform the functions to be described. The microcontroller 212 is powered by a DC source of voltage 214 that can be input from an external source or, preferably, generated by a conventional power supply circuit for converting alternating voltage to a direct voltage Vcc. The limit sensors 124 and 128 as well as the tube count sensor 76 are connected to the controller or microprocessor 212. The pressure sensor 96 is likewise connected to the controller 212 as is the tube delivery stop motor 74 and the fan 132. The display 20a on the control panel 20 is connected to the microcontroller 212 as are green and red LEDs 218, 220, respectively. LED strips to illuminate the interior of the housing 12 and a buzzer 222, 224, respectively, are likewise connected to the microcontroller 212. The switches or buttons 20b on the control panel, namely on/off switch 226, start switch 228, stop/pause switch 230, clean switch 232, up switch 234 and down switch 236 are all connected to the microcontroller 212. The microcontroller monitors the signals at the outputs of the various sensors 124, 128, 76, 130 and 96 as well as the states at the various switches 226, 228, 230, 232, 234, 236, 92a and 92b, and coordinates signals that are issued to control, activate or energize the motors 58, 74, 94 and 102 and fan 132. Appropriate signals are generated by the controller 212 to energize the buzzer 224, the LED strip 222, the LEDs 218, 220 as well the information for display on the display panel 20a.

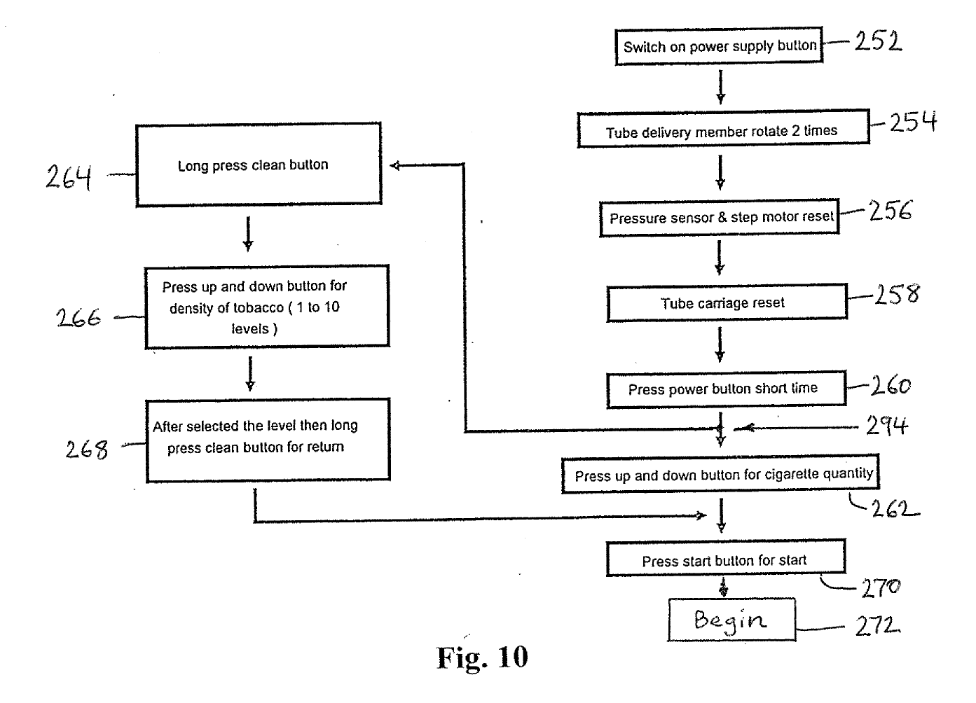

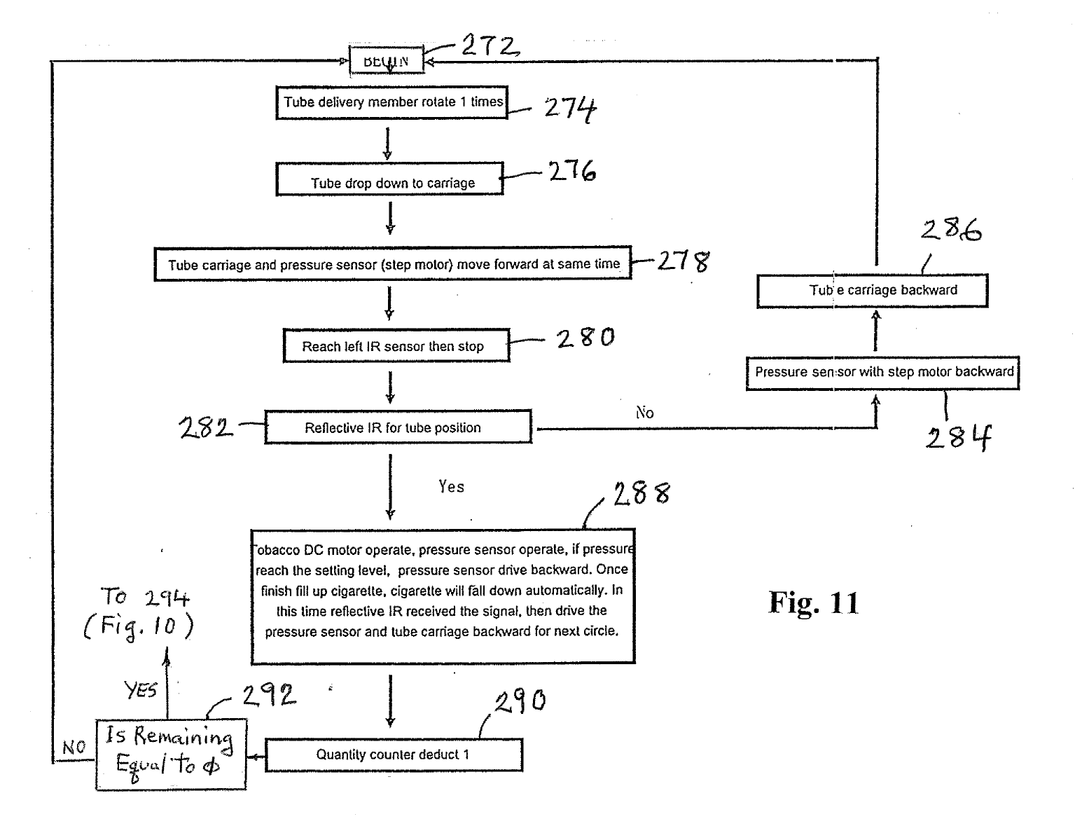

The operation of the machine 10 will be described with reference of the flowcharts shown in FIGS. 10, 11 that represent the program logic or software architecture. Initially, the on-off or power supply button or switch 226 is pressed by the user at 252. The tube delivery member or receiver 72 initially rotates two times at 254 by activation of the step motor 74. This is to ensure that at least one empty tube is delivered onto the receiver 72. The pressure sensor 96 and step motor 94 are reset at 256. The tube carriage 80 position is reset at 258, all these housekeeping functions being performed internally upon the closing of the power or on/off switch 226.

The user now has the option of specifying the quantity of cigarettes to be automatically made in one session. This is achieved by pressing the on/off button 226 a short time, at 260. The up and down buttons 234, 236 can now be pressed as may be appropriate to select the number of cigarettes to be made, at 262. This number is displayed on the display panel 20a and, as indicated, can be modified by the user by pressing the appropriate up or down buttons. Pressing the power button for a longer period of time, at 264, allows the user to select the density or how firmly the tobacco or other material is to be packed, the user being provided a number of options, for example 10 levels of density 1-10, at 266. Clearly, more or less levels can be provided, this being a matter of design choice. After the density setting has been selected the clean button is pressed a long period of time to enter the user settings, which are stored. The machine is now ready to execute the instructions after the start button 228 is pressed at 270. The programmed operations then begin a sequence of steps in accordance with the program stored in the microprocessor or microcontroller 212.

At the beginning of the sequence, at 272, the tube receiver 72 is caused to rotate one time, at 274. An empty tube is caused to drop into the trough 80a of the tube carriage 80. This is implemented by feeding an appropriate signal to the step motor 74. Once the tube sensor 130 senses the presence of a hollow tube in the trough 80a of the tube carriage 80 the drive motor 102 drives the shaft 104 which advances the tube carriage 80 towards the tube filling station 38. At this time, the step motor 94 rotates the threaded shaft 88 to advance the carriage 86 to likewise move in the direction of the tube filling station 38. This is represented at 278 in FIG. 11. When the tube carriage 80 reaches the sensor 128 the carriage stops, at 280. Once the carriage 80 stops the reflective tube sensor 130 detects the presence or absence of a tube within the trough 80a, at 282. If there is no hollow or empty tube on the tube carriage 80 the carriage 86 carrying the pressure sensor 86 is moved backwards, at 284, by the step motor 94. The tube carriage 80 is likewise caused to return to the initial or default position, or rightmost position as viewed in FIGS. 2 and 7. The sequence then commences again at 272 when the receiver or delivery member 72 rotates to drop a tube on the receiver 72.

If the reflective detector or tube sensor 130 has detected the presence of a tube at the tube filling station 38 the DC motor 58 is energized and the output of the pressure sensor 96 is detected to determine if it senses the density level set by the user. If the set pressure level has been reached the pressure sensor on the carriage 86 is returned to the rightmost position. If the desired pressure or density has not yet been reached the DC motor continues to be energized and material from the tube bin 34 continues to be fed into the tube by the feeding auger 56 within the feed tube 99 until the desired packing density has been reached to correspond to the level set by the user. Again, once the desired pressure has been detected by the pressure sensor 96 it moves backward or to the right as viewed in FIGS. 2 and 7 and the finished cigarette is allowed to drop and fall into the drawer 22. At this time, the tube-presence sensor 130 no longer detects a tube within the trough 80a of the tube carriage 80 and the pressure sensor 96 and tube carriage are moved backward or returned towards their rightmost positions for the next cycle, at 288. Once the cycle has been completed the quantity of cigarettes selected by the user is reduced by one, at 290, and the processor or controller 212 determines if the remaining count is equal to zero, at 292. If the count is greater than zero the cycle is repeated by reverting to the beginning of a new cycle at 272. If the remaining count is equal to zero the processor 212 can be programmed to shut down and turn the unit off or can be programmed to go to standby (at 294) to await further user instructions as to a new quantity of cigarettes and/or new density settings for a new session.

Additional details regarding the operation of the machine will now be further described. At the beginning of a cycle a tube falls from the tube storage bin 36 into the trough 80a of the tube carriage 80. At this time, the photo-optical sensor 130, such as a retro-reflective or diffuse reflective sensor, senses that a tube is positioned on the carriage 80 and the motor 102 starts and delivers the tube to the tube packing or filling position 38. When this happens, the photoelectric sensing switch or sensor 128 is turned off so the tube stays in the packing or filling position. At the same time, the stepper motor 94 screw or threaded shaft 88 starts to rotate and moves the pressure sensor 96 forward or towards the left as viewed in FIG. 7 (the pressure sensor 96 is at this point is not yet powered). This motion pushes the tube forward to the designated position and stops. The pressure sensor 96 is powered and activated at this time. The feeding screw or auger 56 fills the tube. When the pressure sensor 96 signals that the tube is full, it will send a signal to the processor or controller 212. The stepper motor 94 re-sets itself by returning the feeding screw or threaded shaft 88. The pressure sensor 96 and the tube carriage are moved back to their original positions for the next fill. Once the original position is reached, the reset is complete and the tube delivery motor 74 starts again for the next fill. This continues until the packing material is all used up or until the cigarette count selected by the user has been reached.

In addition, during the process the packing material inclined panel 46 moves back, the packing material release door opens again and the next tube is dropped to repeat the foregoing packing process.

Some botanical material, not limited to cannabis buds, are packed using rolls of cigarette paper in lieu of tubes to eliminate the use of a filter or to formulate a “joint” with a variable diameter. The casing of the cigarette tube location could be replaced with a rotor that delivers the pre-perforated portion of the rolling paper for filling with the botanical substance. The cigarette “joint” is clipped and discharged in similar motion as with the use of cigarette tubes.

The technical solution employed in the present invention is as follows:

A: Automatic material mixing;

B: Automatic material feeding;

C: Automatic discharging;

D: Pressure sensing control;

E: Stepper drive control;

F: Central integrated control.

### A. Automatic Material Mixing:

The material to be packed is placed into the material bin 34. The machine is turned on to start the drive gear motor 102 after providing the substances to be packed. Two gear shafts 50, 54 are caused to rotate to loosen and mix the material into a uniform state, and then transfer the material to a feeding screw or auger 56. Some materials to be packed, such as marijuana buds, may need grinding prior to the addition to the material tank. In such an application, a grinder 35 is positioned above the material bin 34. The grinder 35 can be powered by an on/off switch on the control panel 20. The grinder opens when the programmed grinding time is up and the grinded material is dropped into the material bin.

### B. Automatic Material Feeding:

The mixed and uniform material is sent from the material bin 34 to the feeding screw compactor or auger 56 through the feeding tube 99 from the left side of the machine towards the center as viewed in FIGS. 2 and 7. At the same time, the tube is delivered via a star fruit gear or tube receiver 72 from the right side of the machine, dropping the tube into the tube receiver transporting the tube towards the center of the machine. The feeding motor 58 starts to turn the feeding screw or auger so that the tobacco material is forced into the tube. The motor 58 can only move in one direction, in other words, the materials discharging direction.

### C. Automatic Discharging:

The tube is gradually filled with the material fed by the feeding screw compactor or auger 56. When the tube is full, the feeding pipe or tube 99 is separated from the tube. An infrared or photo-optical sensor detects the separation of the feeding pipe 99 from the tube, the stepper motor 94 moves away and the pressure sensor 96 quickly separates from the tube. Once the tube carriage is returned to its initial or rightmost position any suitable means can be used to rotate the tube carriage 80 a 90-degree turn which, along with gravitational pull, the tube filled with the botanical material separates from the feeding pipe and falls into the collection drawer or tray 22 below the control panel.

### D. Pressure Sensing Control:

This control functions by converting a mechanical pressure signal into a weak voltage signal. The pressure sensor 96 may be any suitable pressure sensor. In a presently preferred embodiment the sensor has an aluminum structure, and two chips have been attached on its two sides. This pressure sensor is tailored into the required shape and with the two chips welded to the appropriate stress point in order to be able to integrate the pressure signals from the two sides. When mechanical pressure is exerted on the chips, a corresponding electrical signal is sent to the processor 212 according to the magnitude of pressure exerted. The chip is an integrated circuit that is able to sense a pressure or pressure change with a sensitivity differential of +/−0.01 g. In this context, the specific conversion of the mechanical pressure to the voltage by this voltage regulator is as follows: a pressure of 300 g can output a voltage of 4000±150 microvolts under a 10 V voltage. In the case when the mechanical motions are jammed for whatever the reason exceeding the pressure threshold, the voltage regular signal breaks off and the mechanical motions are arrested thus also serving as an anti jamming response.

### E. Stepper Drive Control:

This control mainly functions to amplify the voltage signal sent from the pressure sensor 96 to send a pulse signal to drive the stepper motor 94 to make a rotation movement. In addition, the output shaft of the stepper motor is a screw or threaded shaft 88. In this way, a rotational movement of the screw shaft could then drive a screw nut to make a horizontal linear movement. Further, the screw nut has been provided with a fixing plate for fixing pressure sensors. As a result, when the pressure sensor mentioned previously senses a pressure and sends a voltage signal to the drive control plate. The stepper motor makes rotation movement which further drives the screw nut to make a horizontal linear movement. In this regard, the rotation speed of the stepper motor could be further regulated by fine tuning of the drive control plate. Therefore, the specific working mechanism of the packing machine is as follows: in the case when the stepper motor 94 causes a slow rotational movement, the material to be packed will be tightly packed; while in the case when the stepper motor results in a fast rotational movement, the material to be packed will be packed loosely. As a result, the tightness of the material to be packed can be controlled by adjusting the rotational speed of the stepper motor, according to the specific requirement for the final packed products.

### F. Central Integrated Control:

The working mechanism of the central integrated control IC is as follows: when an infrared sensor picks up the signal that a tube is sent to a tube receiver, motion commences with the tube delivery motor sending the tube to the packing or filling position 38 near the center of the machine. A photoelectric sensor then picks up the signal that the tube is in the packing position, would start the feeding motor to feed the material into the tube. In addition, over the packing process, the tube gradually moves back. As the tube contacts the pressure sensor, the stepper motor starts to run and then drives the pressure sensing plate to move back, until an infrared sensor detects that the tube is full, and the pressure sensing fixing plate quickly moves back to its original position.

In comparison to the currently available packing technologies, the present invention uniquely employs a vertically integrated process from start to finish, totally automating every step of the way and allows the user simply walk away once input materials are loaded. The added option of a QR-Code, Reader and Blue Tooth would allow compliance monitoring and medical follow up. The use of pressure sensors, infrared and electric feedback loop means the production mode is smooth and continuous until the input materials are all used up. The current invention uniquely accommodates various textures, weight, densities and feel of the many plants mentioned. The present invention is able to make fine adjustment according to specific product requirement. The packing machine of the present invention features small size, light weight, good portability, and easy to use with multi-functional options. The machine components could also be taken apart in modular fashion.

While a preferred embodiment of the invention has been described and illustrated above, it should be understood that it is exemplary of the invention is not to be considered as limiting. Additions, omissions, substitutions, and other modifications can be made without departing from the spirit or scope of the present invention. Accordingly, the invention is not to be considered as limited by the foregoing. Various changes and modifications may be made in the construction of the machine described above which fall within the spirit of this invention and all such changes and modifications coming within the scope of the appended claims are embraced thereby.

1. An automatic cigarette-making machine comprising a housing including a material bin for receiving and selectively dispensing a loose combustible substance suitable to be received and packed within a hollow tube to form a cigarette; a tube bin for receiving and selectively dispensing hollow tubes; a filling station; a tube transporting carriage for receiving a tube from said tube bin and selectively transporting a tube between positions at said tube bin and said filling station; filling means for selectively moving the combustible substance from said material bin into a tube at said filling station; a pressure sensor movably positionable proximate to a tube being filled at said filling station to measure or monitor pressure of the combustible substance within the tube while it is being filled; a user interface including means for a user to select a desired compact density or pressure within a tube while it is being filled with a combustible substance into a cigarette at said filling station; control means for selectively actuating said filling means when a tube is positioned within said filling station to feed combustible substance into the tube until the tube is filled and packed to a desired compacted density or pressure of the combustible substance filling means for selectively moving combustible substance from said material bin into a tube at a filling station.

2. A cigarette-making machine as defined in claim 1, wherein said filling station defines an axis and said filling means a loose combustible substance suitable to be received and packed within a hollow tube to form a cigarette.

3. A cigarette-making machine as defined in claim 1, wherein said control means comprises a programmed processor that receives signals from sensors to actuate the movements of combustible material from said material bin, movements of tubes from said tube bin to said filling station, monitoring pressure or density of combustible material within a tube while it is being filled, releasing a completed cigarette and resetting the machine for further use.

4. A cigarette-making machine as defined in claim 1, wherein said user interface comprises a control panel connected to said control means for manual selection of said desired compacted density or pressure.

5. A cigarette-making machine as defined in claim 1, further comprising means for selectively directing a stream of air into a region where said filling means advances combustible material into a tube to clear any loose particles of the combustible material that may interfere with or hamper said filling means from feeding combustible material into a tube.

6. A cigarette-making machine as defined in claim 1, further comprising a grinder positioned above said material bin for allowing combustible material or additives to ground and added into said material bin.

7. A cigarette-making machine as defined in claim 1, wherein said user interface includes a display for displaying user selected input parameters and/or status of the operation of the machine.

8. A cigarette-making machine as defined in claim 1, wherein said control means includes a drive train of gears that selectively function to release tubes from said tube bin onto said tube transporting carriage and release combustible material from said material bin to said filling means.

9. A cigarette-making machine as defined in claim 1, wherein said user interface provides input control to a user to select the number of cigarettes to be automatically made, and further comprising a sensor at a release point of said tube bin for sensing the number of tubes that have been released and deposited onto said tube transporting carriage.

10. A cigarette-making machine as defined in claim 1, wherein said tube transporting carriage and said pressure sensor are movably mounted for independent movements that are controlled by said control means.

11. A cigarette-making machine as defined in claim 1, further comprising a collection or storage drawer for receiving completed cigarettes released by said tube transporting carriage at an end of each cigarette-making cycle.

12. A cigarette-making machine as defined in claim 1, further comprising means for generating feedback signals to a user selected from the group comprising visual and audible signals to inform a user the status of steps taken by said control means.

13. An automatic cigarette-making machine comprising a housing including a material bin for receiving and selectively dispensing a loose combustible substance suitable to be received and packed within a hollow tube to form a cigarette; a tube bin for receiving and selectively dispensing hollow tubes; a filling station; a tube transporting carriage for receiving a tube from said tube bin and selectively transporting a tube between positions at said tube bin and said filling station; filling means for selectively moving the combustible substance from said material bin into a tube at said filling station; a user interface including input means for a user to select a number of cigarettes to be automatically produced in a given production session; a tube release sensor at a release point of said tube bin for sensing the number of tubes that have been released and deposited onto said tube transporting carriage; control means for selectively actuating said filling means when a tube is positioned within said filling station to feed combustible substance into the tube and repeating the filling operation a number of times corresponding to the number of cigarettes selected by the user.

14. A method of automatically producing one or more cigarettes, comprising the steps of depositing a loose combustible substance suitable for being received and packed within a hollow tube to form a cigarette within a material bin; selectively dispensing the loose combustible substance from said material bin; depositing hollow tubes within a tube bin; selectively dispensing hollow tubes from said tube bin; selectively transporting a tube between positions at said tube bin and a filling station; selectively moving the combustible substance from said material bin into a tube at said filling station; selecting by a user a number of cigarettes to be automatically produced in a given production session; sensing the number of tubes that have been released and deposited onto said tube transporting carriage; selectively actuating said filling means when a tube is positioned within said filling station to feed combustible substance into the tube; and repeating the filling operation cycle a number of times corresponding to the number of cigarettes selected by the user.

15. A method as defined in claim 14, wherein the filling station defines a filling axis and the tubes are transported and filled along said filling axis.

16. A method as defined in claim 14, further comprising directing a stream of air into a region where said filling means advances combustible material into a tube to clear any loose particles of the combustible material that may interfere with or hamper said filling means from feeding combustible material into a tube.

17. A method as defined in claim 14, further comprising the step of grinding combustible material and/or additives above the material bin for allowing combustible material and/or additives to be ground and added into said material bin prior to production of cigarettes.

18. A method as defined in claim 14, further comprising the step of selecting a desired compact density or pressure within a tube while it is being filled with a combustible substance into a cigarette at said filling station; selectively actuating said filling means when a tube is positioned within said filling station to feed combustible substance into the tube until the tube is filled and packed to a desired compacted density or pressure of the combustible substance within a tube at the filling station.

19. A method as defined in claim 14, wherein said steps are controlled by monitoring sensors and drives connected to a programmed controller, and controlling said drives by means of the programmed controller in response to signals received by the monitoring sensors.

20. A method as defined in claim 13, further comprising generating by a programmed controller feedback signals to a user selected from the group comprising visual and audible signals to inform a user the status of steps taken by the controller.
